(19) United States
(12) Patent Application Publication
(10) Pub. No.: US 2025/0063580 A1
(43) Pub. Date: Feb. 20, 2025

(54) USER EQUIPMENT AND METHOD FOR SHARED PROCESSING OF UNICAST SERVICE AND MBS BROADCAST SERVICE

(71) Applicant: TCL COMMUNICATION TECHNOLOGY (CHENGDU) LIMITED, Chengdu (CN)

(72) Inventor: Xin ZHANG, Chengdu (CN)

(73) Assignee: TCL COMMUNICATION TECHNOLOGY (CHENGDU) LIMITED, Chengdu (CN)

(21) Appl. No.: 18/723,897

(22) PCT Filed: Jan. 17, 2022
(86) PCT No.: PCT/CN2022/072396

§ 371 Date: Jun. 25, 2024

(51) Int. Cl. H04W 72/30; H04W 76/27

(52) U.S. Cl. CPC H04W 72/30; H04W 76/27

(57) ABSTRACT

Embodiments are directed towards communication methods for UEs to report to base stations about information related to shared processing of unicast service and MBS broadcast service. UEs with processors configured to perform such methods are also introduced.

### TECHNICAL FIELD

The present disclosure relates to wireless communication systems, and more particularly, but not exclusively, to user equipment and method for shared processing of unicast service and MBS broadcast.

### BACKGROUND

To enable resource-efficient delivery of Multicast/Broadcast Services (MBS), 3GPP has developed NR broadcast/multicast in Rel-17 according to the WID in RP-201038, aiming to enable general MBS services over 5GS. MBS is expected to cover diversity of 5G applications and services ranging from public safety, mission critical, V2X, transparent IPv4/IPv6 multicast delivery, IPTV, software delivery over wireless to group communications and IoT applications. Two delivery modes have been agreed for Rel-17 MBS, one being capable of addressing higher QoS services (only for multicast) and the other focusing on lower QoS services (only for broadcast).

Given that Rel-17 already provides basic functions to support MBS, the general main goal for Rel-18 should be enabling better deployment of MBS, such as improvement of resource efficiency and capacity based on Rel-17 MBS.

### BRIEF SUMMARY

Briefly stated, embodiments are directed towards communication methods for UEs to report to base stations information related to shared processing of unicast service and broadcast service. UEs with processors configured to perform such methods are also introduced.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings:

FIG. 1 illustrates UE reporting to a base station upon being triggered according to one embodiment of the present disclosure;

FIG. 2 illustrates UE voluntarily reporting to a base station according to another embodiment of the present disclosure;

FIG. 3 illustrates information included in reports sent from UEs to base stations according to one embodiment of the present disclosure;

FIG. 4 illustrates information included in reports sent from UEs to base stations according to another embodiment of the present disclosure;

FIG. 5 illustrates information included in reports sent from UEs to base stations according to yet another embodiment of the present disclosure;

FIG. 6 illustrates information included in reports sent from UEs to base stations according to a further embodiment of the present disclosure;

FIG. 7 illustrates types of messages adopted by UEs to report to base stations according to a further embodiment of the present disclosure;

FIG. 8 illustrates a communication method according to one embodiment of the present disclosure;

FIG. 9 illustrates another communication method is provided according to one embodiment of the present disclosure; and

FIG. 10 illustrates a block diagram of an example user equipment for wireless communication according to an embodiment of the present disclosure.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the present disclosure. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Herein, “broadcast service” refers to general broadcast service and MBS in Receive Only Mode (ROM).

Herein, “unicast service” refers to services that requires RRC_Connected mode and/or those provided to predetermined UEs.

Herein, base stations refer to gNBs and eNBs, and other possible nodes.

The Rel-17 NR MBS broadcast solution allows UE to receive broadcast service in a downlink only manner, for example performing broadcast reception without accessing network beforehand. However, in typical use case for broadcast, UEs may be required to simultaneously receive broadcast service and unicast service from network(s) of a same or other operator. Therefore, the unicast connection might be impacted by the broadcast reception for this kind of UEs. The optimization for such case is not specifically addressed in Rel-17.

One of the objectives for Rel-18 includes specifying Uu signaling enhancement to enable shared processing for MBS broadcast and unicast reception in a same UE. To achieve such goals, UEs may report information, such as UE capability and related assistance information and so forth, to base stations, for such shared processing of unicast service and MBS broadcast service received from same or different operators.

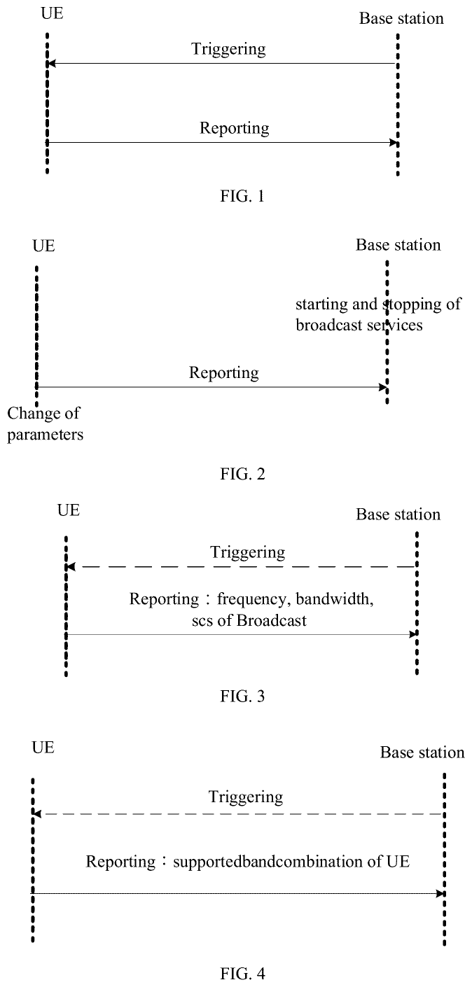

FIG. 1 illustrates UE reporting to a base station upon triggering according to one embodiment of the present disclosure. In this embodiment, base stations may send explicit signaling to trigger UEs to report information related to share processing of unicast and broadcast services.

In one embodiment, the explicit signaling sent by base stations to UEs may be in the form of SIB messages.

In another embodiment, the explicit signaling sent by base stations to UEs may be in the form of MCCH messages.

In other embodiments, other type of broadcast messages may be used as the explicit signaling sent to UEs to trigger sending of such reports.

By using broadcast messages for triggering, such explicit signaling may be received regardless that UEs are in RRC_Connected, RRC_Idle or RRC_Inactive mode.

FIG. 2 illustrates UE voluntarily reporting to a base station according to another embodiment of the present disclosure. In this embodiment, UEs may send such reports to base stations without being triggered/queried.

In one embodiment, UEs may send such reports when broadcast services start and/or stop. In one embodiment, base stations may inform UEs regarding starting and/or stopping of broadcast services.

In another embodiment, UEs may send such reports to base stations when one or more of the UE's parameters change. Such parameters may include parameters related to baseband resource for receiving unicast and/or broadcast service, parameters related to supported bandwidth for receiving unicast and/or broadcast services, parameters indicating UE's willingness in leaving RRC_Connected mode, gap related parameters for network switching, and/or so forth.

In one embodiment, when unicast service and broadcast service are provided by a same base station, UEs may send such reports to this same base station only.

In another embodiment, when unicast services and broadcast services are provided by separate base stations, depending on particular situation, such reports may be sent only to base stations that provide unicast, or only to base stations that provide broadcast, or to any of base stations that provide unicast and base stations that provide broadcast, or to both of base stations that provide unicast and base stations that provide broadcast.

In one embodiment, UEs may send such reports not only to those base stations that send triggering messages to UEs. In another embodiment, UEs may send such reports not only to base stations from which UEs are receiving services.

FIG. 3 illustrates information included in reports sent from UEs to base stations according to one embodiment of the present disclosure. In this embodiment, parameters related to baseband resource for receiving unicast and/or broadcast service may be included in the reports, such as frequency for receiving particular (type of) services, bandwidth that UEs may be able to use, sub-carrier space (SCS) of broadcast service, and so forth.

FIG. 4 illustrates information included in reports sent from UEs to base stations according to another embodiment of the present disclosure. In this embodiment, parameters related to supported bandwidth for receiving unicast and/or broadcast services may be included in such reports, for example supportedbandcombination of a UE, which indicates if UE has the capability to receive unicast service and broadcast service at the same time.

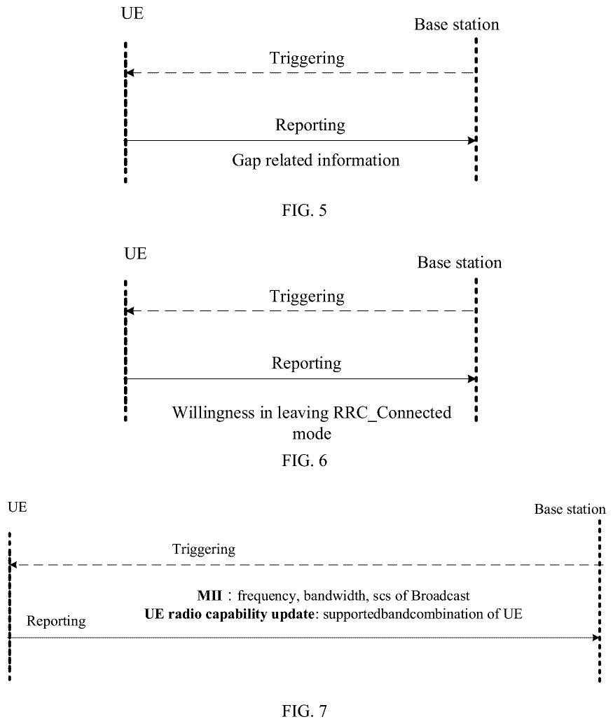

FIG. 5 illustrates information included in reports sent from UEs to base stations according to yet another embodiment of the present disclosure.

In this embodiment, gap related information for network switching may be included in such reports. Herein, a gap refers to the period of time taken by network switching. For example, when UE is receiving unicast service and broadcast service at the same time, and is about to switch to receiving unicast service only, network switching is required and a gap may be introduced during the switching of services. Therefore, UE may send gap related information, including but not limited to gap starting time, duration of a gap, gap repetition period, gap purpose, and so forth, to base stations for shared processing of unicast and broadcast service.

FIG. 6 illustrates information included in reports sent from UEs to base stations according to a further embodiment of the present disclosure.

In this embodiment, UEs may indicate their willingness in leaving RRC_Connected mode in the reports. Unicast services may be received only when UEs are in RRC_Connected mode, whereas broadcast services may be received when UEs are in RRC_Connected, RRC_Idle, or RRC_Inactive mode. For example, UE is receiving unicast service, and is interested in receiving broadcast service. UE may indicate in the reports that if it is willing to leave or stay in RRC_Connected mode.

FIG. 7 illustrates types of messages adopted by UEs to report to base stations according to a further embodiment of the present disclosure.

In this embodiment, such reports may be sent to base stations in form of RRC messages, for example MII (Multicast interest indication) messages, UE capability report related messages (for example, UECpabilityInformation, UE radio capability update), UEAssistanceInformation messages, or other RRC messages, or combination of one or more of the above. For example, baseband resource related parameters (e.g. frequency, bandwidth, SCS) may be reported via MII messages, whereas supported bandwidth for unicast and/or broadcast services related parameters (e.g. supportedbandcomination of UE) may be reported via UE capability report related messages.

In one embodiment, base stations may enable or disable UE sending such reports, for example, indicators may be included in messages such as SIB or MCCH to enable or disable such reports.

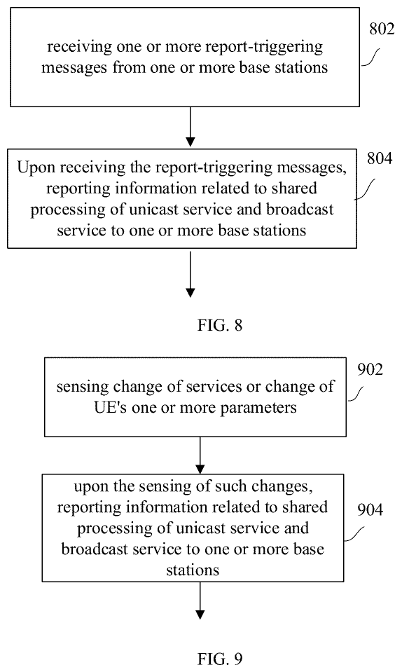

FIG. 8 illustrates a communication method according to one embodiment of the present disclosure.

At 802, receiving one or more report-triggering messages from one or more base stations. In one embodiment, the one or more report-triggering messages may be in form of SIB messages, MCCH messages, or other broadcast messages.

At 804, upon receiving the one or more report triggering messages, reporting information related to shared processing of unicast service and broadcast service to one or more base stations.

In one embodiment, information related to shared processing of unicast service and broadcast service may include parameters related to baseband resource for receiving unicast and/or broadcast service, such as frequency for receiving particular (type of) services, bandwidth that UEs may be able to use, sub-carrier space (SCS), and so forth.

In one embodiment, information related to shared processing of unicast service and broadcast service may include one or more parameters related to supported bandwidth for receiving unicast and/or broadcast services, such as supportedbandcombination of a UE, which indicates if the UE has the capability to receive unicast service and broadcast service at the same time.

In one embodiment, information related to shared processing of unicast service and broadcast service may include gap related information for network switching. For example, when UE is receiving unicast service and broadcast service at the same time, and is about to switch to receive unicast service only, network switching is required. Therefore, gap related information may include but not limited to gap starting time, duration of a gap, gap repetition period, gap purpose, and so forth.

In one embodiment, information related to shared processing of unicast service and broadcast service may include indicators of UE's willingness in leaving RRC_Connected mode. Unicast services may be received only when UEs are in RRC_Connected mode, whereas broadcast services may be received when UEs are in RRC_Connected, RRC_Idle, or RRC_Inactive mode. For example, UE is receiving unicast service, and is interested in receiving broadcast service. UE may indicate in the report that if it is willing to leave or stay in RRC_Connected mode.

In one embodiment, when unicast services and broadcast services are provided by a same base station, UEs may report to the same base station only.

In another embodiment, when unicast services and broadcast services are provided by separate base stations, depending on particular situation, UEs may only report to base stations that provide unicast, or only to base stations that provide broadcast, or to any of base stations that provide unicast and base stations that provide broadcast, or to both of base stations that provide unicast and base stations that provide broadcast. In one embodiment, UEs may send such reports not only to those base stations that send triggering messages. In another embodiment, UEs may send such reports not only to base stations which UEs are receiving services from.

In one embodiment, UEs may report to base stations in form of RRC messages, for example MII messages, UE capability report related messages (for example, UECpability Information, UE radio capability update), UEAssistanceInformation messages, or other RRC messages, or combination of one or more of the above. For example, baseband resource related parameters (e.g. frequency, bandwidth, SCS) may be reported via MII message, whereas supported bandwidth for unicast and/or broadcast services related parameters (e.g. supportedbandcomination of UE) may be reported via UE capability report related messages.

In one embodiment, an exemplary functionality of a UE may be operable for above communication. The UE may comprise one or more processors. The one or more processors can be configured to perform operations stated above. Such UEs may be able to receive and process unicast service and broadcast service with shared hardware resource.

FIG. 9 illustrates another communication method is provided according to one embodiment of the present disclosure.

At 902, sensing change of services or change of UE's one or more parameters.

In one embodiment, UEs may be informed by base stations when broadcast services start and/or stop, which may constitute incentive of UE's reporting of information related to shared processing of unicast services and broadcast services.

In another embodiment, UEs may sense or determine change of one or more of their own parameters, which may constitute incentive of UE's reporting of information related to shared processing of unicast services and broadcast services. Such parameters may include parameters related to baseband resource for receiving unicast and/or broadcast service, parameters related to supported bandwidth for receiving unicast and/or broadcast services, parameters indicating UE's willingness in leaving RRC_Connected mode, gap related parameters for network switching, and/or so forth.

At 904, upon the sensing of such change, reporting information related to shared processing of unicast service and broadcast service to one or more base stations.

In one embodiment, information related to shared processing of unicast service and broadcast service may include parameters related to baseband resource for receiving unicast and/or broadcast service, such as frequency for receiving particular (type of) services, bandwidth that UEs may be able to use, sub-carrier space (SCS), and so forth.

In one embodiment, information related to shared processing of unicast service and broadcast service may include one or more parameters related to supported bandwidth for receiving unicast and/or broadcast services, such as supportedbandcombination of a UE, which indicates if the UE has the capability to receive unicast service and broadcast service at the same time.

In one embodiment, information related to shared processing of unicast service and broadcast service may include gap related information for network switching. For example, when UE is receiving unicast service and broadcast service at the same time, and is about to switch to receive unicast service only, network switching is required. Therefore, gap related information that UEs send to base stations may include but not limited to gap starting time, duration of a gap, gap repetition period, gap purpose, and so forth.

In one embodiment, information related to shared processing of unicast service and broadcast service may include an indicator of UE's willingness in leaving RRC_Connected mode. Unicast services may be received only when UEs are in RRC_Connected mode, whereas broadcast services may be received when UEs are in RRC_Connected, RRC_Idle, or RRC_Inactive mode. For example, UE is receiving unicast service, and is interested in receiving broadcast service. UE may indicate in the reports that if it is willing to leave or stay in RRC_Connected mode.

In one embodiment, when unicast services and broadcast services are provided by a same base station, UEs may report to the same base station only.

In another embodiment, when unicast services and broadcast services are provided by separate base stations, depending on particular situation, UEs may only report to base stations that provide unicast, or only to base stations that provide broadcast, or to any of base stations that provide unicast and base stations that provide broadcast, or to both of base stations that provide unicast and base stations that provide broadcast. In one embodiment, UEs may send such reports not only to base stations which UEs are receiving services from.

In one embodiment, UEs may report to base stations in form of RRC messages, for example MII messages, UE capability report related messages (for example, UECpabilityInformation, UE radio capability update), UEAssistanceInformation messages, or other RRC messages, or combination of one or more of the above. For example, baseband resource related parameters (e.g. frequency, bandwidth, SCS) may be reported via MII message, whereas supported bandwidth for unicast and/or broadcast services related parameters (e.g. supportedbandcomination of UE) may be reported via UE capability report related messages.

In one embodiment, an exemplary functionality of a UE may be operable for above communication. The UE may comprise one or more processors. The one or more processors can be configured to perform operations stated above. Such UEs may be able to receive and process unicast service and broadcast service with a shared hardware resource.

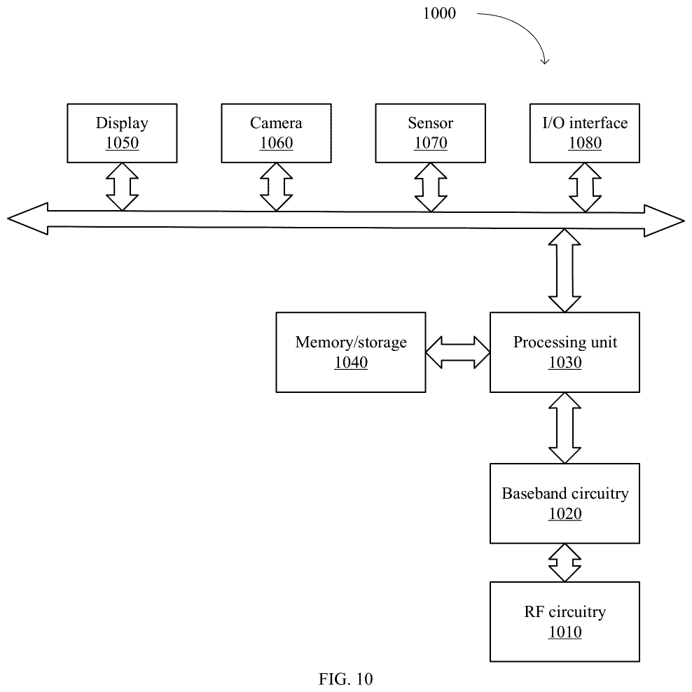

FIG. 10 illustrates a block diagram of an example user equipment for wireless communication according to an embodiment of the present disclosure. Embodiments described herein may be implemented into the system using any suitably configured hardware and/or software. FIG. 10 illustrates the system 1000 including a radio frequency (RF) circuitry 1010, a baseband circuitry 1020, a processing unit 1030, a memory/storage 1040, a display 1050, a camera 1060, a sensor 1070, and an input/output (I/O) interface 1080, coupled with each other as illustrated.

The processing unit 1030 may include circuitry, such as, but not limited to, one or more single-core or multi-core processors. The processors may include any combinations of general-purpose processors and dedicated processors, such as graphics processors and disclosure processors. The processors may be coupled with the memory/storage and configured to execute instructions stored in the memory/storage to enable various disclosures and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 1020 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 1000 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

Embodiments in the present disclosure enables UEs to receive and process unicast service and MBS broadcast service simultaneously with shared hardware resource.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A communication method, executable in a user equipment, comprising:
receiving one or more report-triggering messages from one or more base stations; and
upon receiving the one or more report-triggering messages, reporting information related to shared processing of unicast service and broadcast service to one or more base stations.

2. The method of claim 1, wherein the one or more report-triggering messages are broadcast messages.

3. The method of claim 2, wherein the broadcast messages include SIB messages, and/or MCCH messages.

4. The method of claim 1, wherein the information related to shared processing of unicast service and broadcast service includes parameters related to baseband resource for receiving unicast and/or broadcast service.

5. The method of claim 4, wherein the parameters related to baseband resource for receiving unicast and/or broadcast service include: frequency for receiving particular (type of) services, bandwidth that UE is able to use, and/or sub-carrier space (SCS).

6. The method of claim 1, wherein the information related to shared processing of unicast service and broadcast service includes one or more parameters related to supported bandwidth for receiving unicast and/or broadcast services.

7. The method of claim 6, wherein the one or more parameters related to supported bandwidth for receiving unicast and/or broadcast services include supportedbandcombination of UE.

8. The method of claim 1, wherein the information related to shared processing of unicast service and broadcast service includes gap related information for network switching.

9. The method of claim 8, wherein the gap related information includes gap starting time, duration of a gap, gap repetition period, and/or gap purpose.

10. The method of claim 1, wherein the information related to shared processing of unicast service and broadcast service includes an indicator of UE's willingness in leaving RRC_Connected mode.

11. The method of claim 1, wherein when unicast services and broadcast services are provided by a same base station, reporting only to the same base station.

12. The method of claim 1, wherein when unicast services and broadcast services are provided by separate base stations, reporting only to base stations that provide unicast, or only to base stations that provide broadcast, or to any of base stations that provide unicast and base stations that provide broadcast, or to both of base stations that provide unicast and base stations that provide broadcast.

13. The method of claim 1, wherein said reporting is in form of one or more RRC messages.

14. The method of claim 13, wherein the one or more RRC messages include one or more MII messages, UE capability report related messages, and/or UEAssistanceInformation messages.

15. The method of claim 14, wherein the one or more UE capability report related messages include UECpabilityInformation, and/or UE radio capability update.

16. A user equipment, comprising: a processor, configured to call and run a computer program stored in a memory to execute the method of claim 1.

17. A communication method, executable in a user equipment, comprising:
sensing change of services or change of UE's one or more parameters; and upon the sensing of such change, reporting information related to shared processing of unicast service and broadcast service to one or more base stations.

18-29. (canceled)

30. A user equipment, comprising: a processor, configured to call and run a computer program stored in a memory to execute the method of claim 17.

31. A communication system, comprising one or more base stations and one or more UEs of claim 16.

32. The communication system of claim 31, wherein the one or more base stations have the capability to enable or disable the UEs to report information related to shared processing of unicast service and broadcast service.
